(19) United States
(12) Patent Application Publication
(10) Pub. No.: US 2015/0018200 A1
(43) Pub. Date: Jan. 15, 2015

(54) Using Immiscible Liquid-Liquid Systems to Control the Dealloying of Non-Noble Metals From alloy Particles Containing Noble Metals

(71) Applicant: GM GLOBAL TECHNOLOGY OPERATIONS LLC, DETROIT, MI (US)

(72) Inventors: MOHAMMED ATWAN, WINDSOR (CA); MICHAEL K. CARPENTER, TROY, MI (US)

(21) Appl. No.: 14/325,735

(22) Filed: Jul. 8, 2014

Related U.S. Application Data
(60) Provisional application No. 61/846,335, filed on Jul. 15, 2013.

(51) Int. Cl. H01M 4/92

(52) U.S. Cl. CPC H01M 4/921; H01M 4/926
USPC 502/185; 502/301; 502/182

(57) ABSTRACT

A method of controlling the de-alloying of metal alloy particles for fuel cell catalyst layers includes a step of forming a two-phase liquid system that comprises a first liquid and a second liquid. The first liquid is immiscible with the second liquid and the second liquid contains an acid. Metal alloy particles are added to the two-phase system to form a particle-containing liquid mixture. The particle-containing liquid mixture is agitated such that etched metal alloy particles are formed. The resulting etched metal alloy particles are then advantageously used to form fuel cell catalyst layers.

### CROSS-REFERENCE TO RELATED APPLICATION

This application claims the benefit of U.S. provisional application Ser. No. 61/846,335 filed Jul. 15, 2013, the disclosure of which is hereby incorporated in its entirety by reference herein.

### TECHNICAL FIELD

The present invention is related to a method of making de-alloyed (leached) catalysts to be used in fuel cell applications.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode catalyst layers of a typical PEM fuel cell are typically thin films formed by dried inks Each electrode has finely divided catalyst particles (for example, platinum particles) supported on carbon particles to promote oxidation of hydrogen at the anode and reduction of oxygen at the cathode. Protons flow from the anode through the ionically conductive polymer membrane to the cathode where they combine with oxygen to form water which is discharged from the cell. The MEA is sandwiched between a pair of electrically conductive porous gas diffusion layers (“GDL”) which, in turn, are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells arranged in stacks in order to provide high levels of electrical power. Although the catalyst layers used in fuel cells work reasonably well, such layers tend to be expensive.

In at least some prior art methods, the catalyst layers of a fuel cell include metal alloy particles that are subjected to leaching prior to incorporation into a fuel cell. Such leaching has typically involved simple immersion of a sample into an aqueous acid solution of a particular concentration.

Accordingly, there is a need for improved methods of processing metal alloy particles for fuel cell applications.

### SUMMARY

The present invention solves one or more problems of the prior art by providing in at least one embodiment etched metal alloy particles with a reduced amount of voids and depressions, and/or a desired distribution of metals within the particles. The method includes a step of combining a first liquid with a second liquid to form a two phase system. Characteristically, the first liquid is immiscible with the second liquid. Supported metal alloy particles are added to the two phase system and then agitated such that etched metal alloy particles are formed. The effective leach rate of non-noble metals from alloy nanoparticles is accomplished by controlling the access of the etchant to the particle surfaces. Specifically, alloy particles dispersed in a hydrophobic phase are stirred together with an aqueous etchant phase (typically an acid solution). Control of the mixing (stirring, sonication) of this two-phase mixture, in addition to tailoring the hydrophobic phase characteristics, allows fine-tuning of the metal leach rate. Moreover, the two phase system of the present invention allows for more precise control of the leaching rate by controlling the access of the etchant to the particle surfaces with the variables of stirring rate, capping agent identity (e.g., oleylamine, polyvinylpyrrolidone, and polyethylene glycol) and concentration, and the relative amounts of the immiscible liquid phases.

In another embodiment, a method of controlling de-alloying of metal alloy particles for fuel cell catalyst layers is provided. The method includes a step of forming a two phase liquid system that includes a first liquid and a second liquid. The first liquid is immiscible with the second liquid. The second liquid is an aqueous acid while the second liquid is an organic liquid. Supported platinum alloy particles are added to the two-phase system to form a particle-containing liquid mixture. The particle-containing liquid mixture is agitated to form etched metal alloy particles. Characteristically, the agitation causes droplets of the first liquid to form in the second liquid and/or droplets of the second liquid to form in the first liquid.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell that incorporates a polymer electrolyte membrane including catalyst layers; and

FIGS. 2A and 2B are a schematic flow chart illustrating a method of leaching non-noble metal(s) alloyed from metal alloy particles.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; molecular weights provided for any polymers refer to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

“ICP-OES” is inductively coupled plasma optical emission spectroscopy.

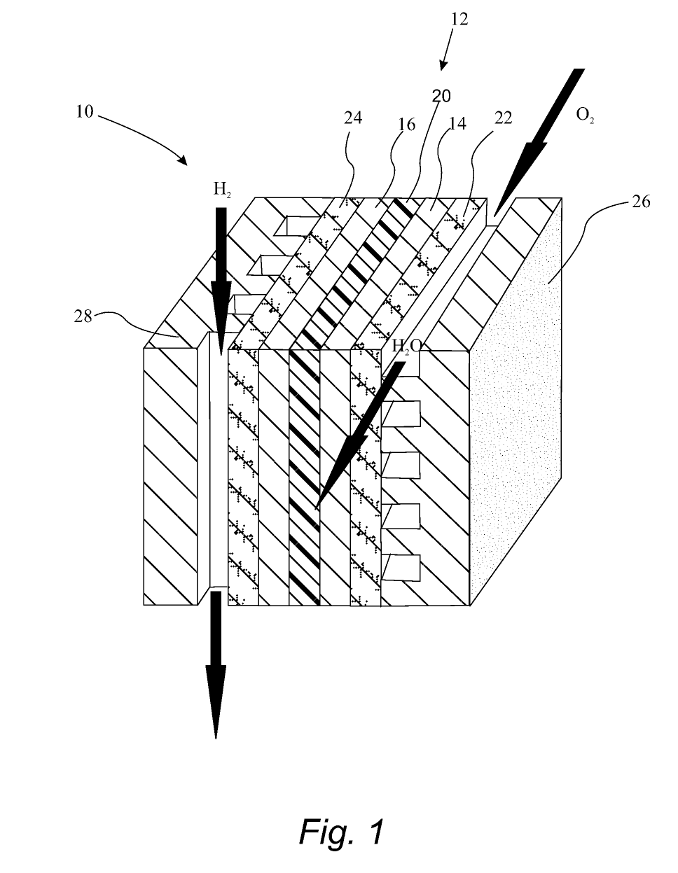

With reference to FIG. 1, a fuel cell having a membrane electrode assembly that incorporates catalyst layers is provided. Fuel cell 10 includes the membrane electrode assembly 12 which includes anode catalyst layer 16, cathode catalyst layer 14, and ion conducting membrane (i.e., proton exchange membrane) 20. Proton (i.e., ion) conducting membrane 20 is interposed between anode catalyst layer 16 and cathode catalyst layer 14 with anode catalyst layer 16 disposed over the first side of proton conducting membrane 20 and cathode catalyst layer 14 disposed over the second side of proton conducting membrane 20. Characteristically, one or both of anode catalyst layer 16 and cathode catalyst layer 14 includes etched metal alloy particles formed by the method set forth below. In a variation, fuel cell 10 also includes porous gas diffusion layers 22 and 24. Gas diffusion layer 22 is disposed over cathode catalyst layer 14 while gas diffusion layer 24 is disposed over anode catalyst layer 16. In yet another variation, fuel cell 10 includes anode flow field plate 28 disposed over gas diffusion layer 24 and cathode flow field plate 26 disposed over gas diffusion layer 22. Additional details of fuel cell 10 are set forth above in the background section.

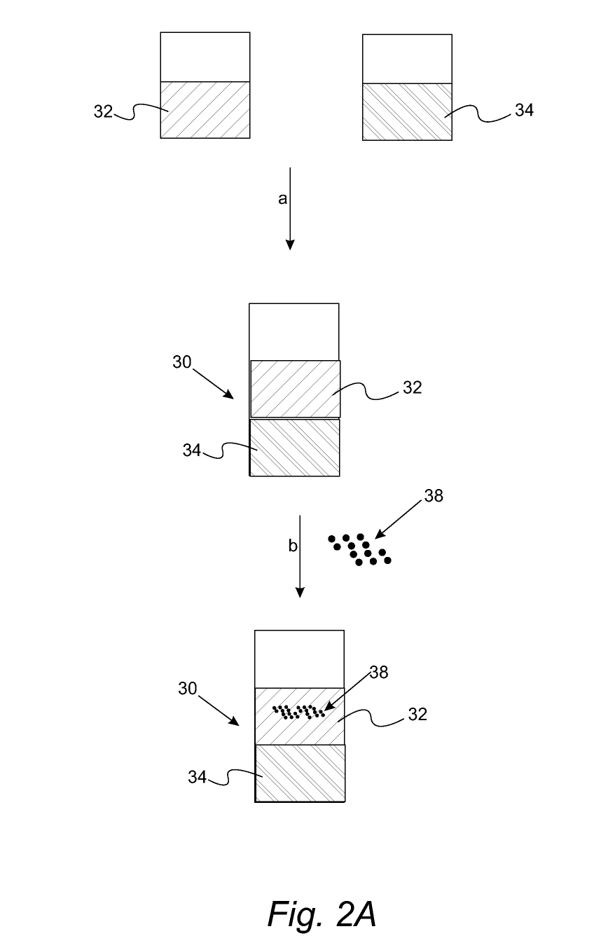

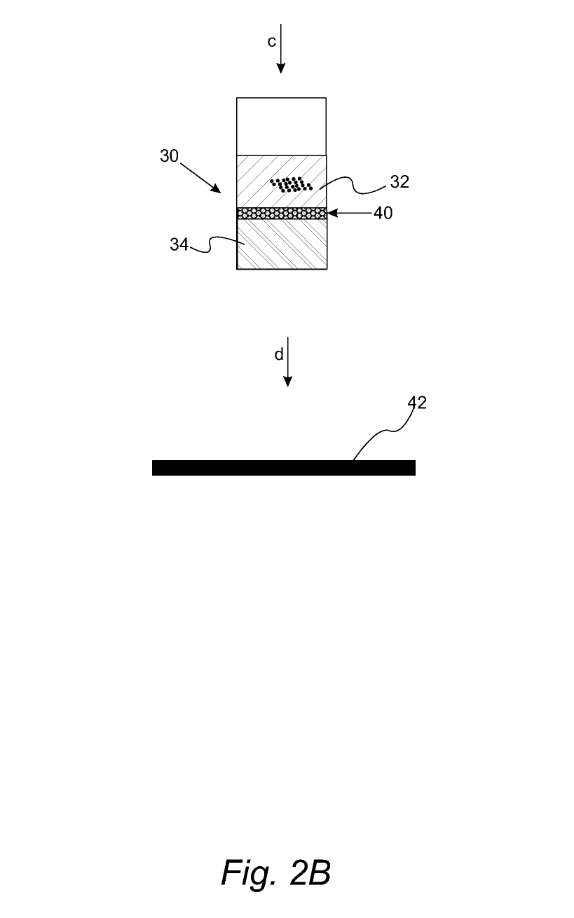

With reference to FIGS. 2A and 2B, a schematic flow chart illustrating the formation of etched metal alloy particles is provided. In general, a combination of a first liquid (a hydrophobic liquid), a second liquid (i.e., an aqueous acid), and metal alloy particles are agitated (e.g., stirred) such that a non-noble metal is leached from the metal alloy particles. It should be appreciated that the metal alloy particles are catalytic particles that are useful in fuel cell applications. In a refinement, the metal alloy particles have a size in the range from 1 to 1000 nm, in particular 5 to 200 nm, and preferably 10 to 100 nm. In a variation, the metal alloy particles include metal alloy disposed on support particles. The support particles can be formed from any material having sufficiently high surface area to be used in a fuel cell. In a variation, the support particles are electrically conductive particles, non-electrically conductive particles, semiconducting particles, or combinations thereof. Examples of suitable conductive support particles include, but are not limited to, carbon black, graphite, carbon nanotubes, activated carbon, and combinations thereof. Examples of suitable non-electrically conductive or semiconducting support particles include, but are not limited to, niobium oxide, titanium oxide, and combinations thereof (e.g. niobium doped titanium oxide). In a refinement, the metal alloy particles are a finely divided precious metal having catalytic activity.

In step a) a two phase liquid system 30 is formed by combining first liquid 32 and second liquid 34. Typically, first liquid 32 is an organic liquid and second liquid 34 is an aqueous acid. Moreover, first liquid 32 is usually hydrophobic while second liquid 34 is hydrophilic. Examples of suitable organic liquids for first liquid 32 include, but are not limited to, C₄₋₁₂ hydrocarbons (alkanes) such as hexane, heptane, octane, nonane, and the like. Additional examples of suitable organic liquids for first liquid 32 include C₆₋₁₀ aromatic compounds, such as benzene, toluene, xylene, and the like. It should be appreciated that virtually any organic solvent may be used for first liquid 32 as long as such liquid is immiscible in second liquid 34. In another refinement, second liquid 34 is an aqueous acid having a pH less than 7. In another refinement, second liquid 34 has a pH greater than 0.5. In still another refinement, second liquid 34 is an aqueous acid having a pH less than, in increasing order of preference, 7, 6, 5, 4, or 3. In yet another refinement, second liquid 34 is an aqueous acid having a pH greater than, in increasing order of pH 0.5, 1, 1.5, or 2. In a variation, the volume ratio of first liquid 32 and second liquid 34 is from 1:10 to 10:1. In another variation, the volume ratio of first liquid 32 and second liquid 34 is from 1:10 to 2:1. In still another variation, the volume ratio of first liquid 32 and second liquid 34 is from 1:5 to 1:1. In still another variation, the volume ratio of first liquid 32 and second liquid 34 is from 1:5 to 1:2. In another refinement, second liquid 34 is an aqueous acid having a pH less than, in increasing order of preference, 5, 3, and 2. Examples of acids used in aqueous 34 include sulfuric acid, nitric acid, and hydrochloric acid. In general, first liquid 32 is immiscible in second liquid phase 34. In step b), metal alloy particles 38 are introduced into two phase liquid system 30. At this point, the system is formally a three phase system. Typically, these particles will predominately reside in the hydrophobic phase—first liquid 32. Moreover, such metal alloy particles may include a support such as carbon. In general, the metal alloy particles include non-noble metal(s) alloyed with noble metal(s). Examples of noble metals that are useful in the present invention include ruthenium, rhodium, palladium, silver, osmium, iridium, platinum, and gold. In particular, useful noble metals are platinum, palladium, iridium, rhodium, ruthenium. In one particularly useful refinement, the metal alloy particles are platinum alloy particles. Examples of suitable metals to alloy with the noble metals include nickel, iron, cobalt, titanium, chromium, copper, and combinations. In a refinement, nickel is a particularly prevalent metal found in these alloys. In step c), the two phase system is agitated (e.g., stirred, vibrated, etc.). Typically, the two-phase system is agitated at a temperature from about 5° C. to 80° C. In a refinement, the two phase system is agitated at about room temperature (i.e., 25° C.). In a refinement, the agitation is sufficiently vigorous to form droplets 40 of one phase in another thereby allowing aqueous acid to contact the metal alloy particles to form etched metal alloy particles. In a refinement, the etching is observed to proceed without the formation of depressions and voids in the alloy particles. In one variation, droplets 40 have an average spatial dimension (e.g., diameter) less than about 100 nm with 2 to 30 nm being typical. In another variation, droplets 40 have an average spatial dimension (e.g., diameter) less than about 1000 nm with 400 to 700 nm being typical. In step d), the metal alloy particles are incorporated into fuel cell catalyst layer 42.

The average droplet size for two-phase agitation systems depends on the physical properties of the two phases, the dispersed phase concentration, and the agitation system dimensions and features such as impeller (stirrer) type and diameter, and tank diameter. For Water-Hexane systems, the droplet size may be predicted according to the following formula:

d₃₂/d=0.052We^{-0.6}e^{4φ}
d₃₂=Sauter diameter (droplet mean diameter)
d=Impeller diameter
We=Weber number=p_{c}d³n²/σ
φ=Volume fraction of dispersed phase
P_{c}=Density of continuous phase
n=Rotation per second
σ=Interfacial tension

In a variation, the etched metal alloy particles are combined with an ion-conducting polymer and optional solvents to form a catalyst-containing ink composition. The ion-conducting polymers typically include protogenic groups such as —SO₂X, —PO₃H₂, —COX, and combinations thereof where X is —OH, a halogen, or an ester. Examples of suitable ion-conducting polymers include, but are not limited to, perfluorosulfonic acid polymers (PFSA), hydrocarbon based ionomers, sulfonated polyether ether ketone polymers, perfluorocyclobutane polymers, and combinations thereof. A particularly useful ion-conducting polymer is NAFION® which is a perfluorosulfonic acid polymer. Examples of suitable solvents include water, alcohols (ethanol, methanol, and the like), and combinations thereof. Such etched metal-containing ink compositions are advantageously used to form fuel cell catalyst layers (i.e. anode catalyst layers and cathode catalyst layers) and in particular, cathode catalyst layers.

In a variation, the ink composition includes the etched metal particles in an amount of 1 to 20 weight percent of the total weight of the ink composition. In a refinement, the ink composition includes the etched metal particles in an amount of 1 to 10 weight percent. In a variation, the ion conducting polymer is present in an amount of 1 to 20 weight percent of the total weight of the ink composition. In these inks, the solvent(s) makes up the balance of the composition.

In a refinement, the catalyst layers formed from the ink composition have a thickness in the range from 1 to 1000 microns, in particular, from 5 to 500 microns, preferably from 10 to 300 microns. In another refinement, the catalyst content (e.g., platinum loading) of the catalyst layer is from 0.05 to 10.0 mg/cm². In a further refinement, the catalyst content is from 0.1 to 6.0 mg/cm². In still another refinement, the catalyst content is from 0.1 to 3.0 mg/cm².

The following examples illustrate the various embodiments of the present invention. Those skilled in the art will recognize many variations that are within the spirit of the present invention and scope of the claims.

Table 1 provides the etching results for carbon-supported platinum nickel alloy particles introduced into a solvent/aqueous acid system. The solvent in this example is hexane. The stirring rates of the stirred samples are identical. The label “Static” indicates that the sample was not stirred. The pH of the aqueous acid is about 2 (i.e., a 1 molar sulfuric acid solution). In one sample, as indicated in Table 1, the hydrophilic phase is 100 percent acid. The etch rate of nickel is observed to be higher with stirring than the static case. Moreover, the etch rate is observed to be higher at the lower volume ratio of solvent to aqueous acid.

TABLE 1
Two-phase leaching of Pt alloy catalyst (12/23)

| Solvent/aqueous | Stir | Atomic % from ICP-OES | |
|---|---|---|---|
| acid | Time | Atom % Ni in the platinum | % of Ni |
| (volume ratio) | (hr) | alloy nanoparticles | removed |
| Catalyst prior to | — | 21.8 | — |
| etching | | | |
| 3/2 | 5 (Static) | 21.6 | 0 |
| 3/2 | 5 | 20.2 | 7.3 |
| 1/3 | 5 | 18.9 | 13.3 |
| 100% acid | 5 | 16.8 | 22.5 |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of controlling de-alloying of metal alloy particles for fuel cell catalyst layers, the method comprising:
forming a two-phase liquid system that includes a first liquid and a second liquid, the first liquid being immiscible with the second liquid, the second liquid including an acid;
adding metal alloy particles to the two-phase system to form a particle-containing liquid mixture; and
agitating the particle-containing liquid mixture such that etched metal alloy particles are formed.

2. The method of claim 1 wherein the second liquid is an aqueous acid solution.

3. The method of claim 2 wherein the second liquid has a pH less than 7.

4. The method of claim 2 wherein the first liquid is an organic liquid.

5. The method of claim 4 wherein the first liquid is a C₄₋₁₂ hydrocarbon.

6. The method of claim 1 wherein the two-phase system is agitated by stirring such that droplets of the first liquid form in the second liquid and/or droplets of the second liquid form in the first liquid.

7. The method of claim 1 wherein the metal alloy particles include platinum, palladium, iridium, rhodium, ruthenium and a first row transition metal.

8. The method of claim 7 wherein the metal alloy particles include platinum.

9. The method of claim 8 wherein the metal alloy particles further include nickel.

10. The method of claim 1 wherein the metal alloy particles are supported on carbon particles.

11. The method of claim 1 further comprising incorporating the metal alloy particles into an ink composition.

12. The method of claim 11 further comprising forming a fuel cell catalyst layer from the ink composition.

13. A method of controlling de-alloying of metal alloy particles for fuel cell catalyst layers, the method comprising:
forming a two-phase liquid system that includes a first liquid and a second liquid, the first liquid being immiscible with the second liquid, the second liquid being an aqueous acid and the first liquid being an organic liquid;
adding supported platinum alloy particles to the two-phase system to form a particle-containing liquid mixture; and
agitating the particle-containing liquid mixture to form etched metal alloy particles wherein agitation causes droplets of the first liquid to form in the second liquid and/or droplets of the second liquid to form in the first liquid.

14. The method of claim 13 wherein the two phase system is agitated by stirring.

15. The method of claim 13 wherein the platinum alloy particles include a first row transition metal.

16. The method of claim 15 wherein the first row transition metal is selected from the group consisting of nickel, iron, cobalt, titanium, chromium, copper, and combinations thereof.

17. The method of claim 15 wherein the first row transition metal is nickel.

18. The method of claim 13 wherein the supported platinum alloy particles include a component selected from the group consisting of carbon black, graphite, carbon nanotubes, activated carbon, niobium oxide, titanium oxide, and combinations thereof.

19. The method of claim 13 wherein the droplets have an average spatial dimension from 2 to 30 nm.

20. The method of claim 13 wherein the droplets have an average spatial dimension from 400 to 700 nm.
